(19) United States
(12) Patent Application Publication
(10) Pub. No.: US 2008/0046721 A1
(43) Pub. Date: Feb. 21, 2008

(54) Dynamic multiprovider

(76) Inventors: Thomas Zurek, Walldorf (DE); Bernhard Hornung, Walldorf (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/504,916

(22) Filed: Aug. 15, 2006

(51) Int. Cl. H04L 9/00

(52) U.S. Cl. 713/157

(57) ABSTRACT

A selection of a plurality of data sources which characterize characteristics and key figures are received. Thereafter, a multiprovider is dynamically generated that is based on the selection and which includes characteristics and key figures from each of the selected data sources. Queries may then be run on top of the multiprovider and reported. Related apparatus, systems, methods, and articles are also described.

### TECHNICAL FIELD

The subject matter described herein relates to a multiprovider that allows for dynamic configuration.

### BACKGROUND

Infoproviders are meta data objects in a database that can be uniformly seen as data providers within a query definition, and whose data can also be reported uniformly. Infoproviders can include infocubes (i.e., a quantity of relational tables arranged according to the star schema, etc.), ODS objects (i.e., a storage location for consolidated and cleaned-up transaction data or master data on a document (atomic) level, etc.), infoobjects (i.e., business evaluation objects, etc.), and infosets (i.e., combined data sets, etc.) and the like. A multiprovider is a type of infoprovider that combines data from a number of infoproviders and makes it available for reporting purposes. The multiprovider does not itself contain any data. Its data comes entirely from the infoproviders on which it is based. Such infoproviders can be connected to one another by a union operation.

Infoproviders and multiproviders are the objects or views that are relevant for reporting. A multiprovider is useful in that it can allow a user to run reports using several infoproviders.

As stated, a multiprovider does not contain any data, but rather it is a meta data object. A multiprovider can define

1. Participating (atomic) infoproviders (also referred to as part-providers);

2. Infoobjects (characteristics, key figures) in the multiprovider; and

3. Mapping of the infoobjects in the part-providers to the infoobjects in the multiprovider.

With previous arrangements, each of the three above steps were manually defined during design-time. Typically, this definition occured well in advance before a user first runs a query on such a multiprovider. As a result, the definition of a multiprovider and its usage are separated time-wise and role-wise which resulted in delays in optimizing reporting which in turn unnecessarily consumed processing and human resources.

### SUMMARY

A selection of a plurality of data sources (e.g., infoprovider, collection of infoobjects, etc.) that characterize characteristics and key figures is received. In response to this selection, a multiprovider based on the selection is dynamically generated. This multiprovider includes characteristics and key figures from each of the selected data sources. After the multiprovider is generated, queries may be run on top of the multiprovider and responsive results reported.

In some implementations, duplicative characteristics and/or key figures from the data sources are removed. In other implementations, all characteristics and/or key figures from the data sources are included in the multiprovider.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. Although conventional multiproviders permit the combination and analysis of data from separate physical stores (i.e., a multiprovider avoids that data having to be combined and copied to an additional physical store before it can be analyzed), the subject matter described herein provides significant improvements. For example, a user can dynamically select a set of infoproviders which are then combined to form a multiprovider so that a new query generated by the user can be defined on top of the multiprovider. Previously, the generation of a multiprovider and any resulting queries was decoupled which resulted in certain inefficiencies.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a dynamic generation of a multiprovider;

FIG. 2 is a diagram illustrating characteristics and key figures of three infoproviders;

FIG. 3 is a diagram illustrating the infoproviders of FIG. 2 populated with data;

FIG. 4 is a diagram illustrating a mapping of characteristics and key figures of the infoproviders of FIG. 2 to characteristics and key figures of a multiprovider; and

FIG. 5 is a diagram illustrating the multiprovider of FIG. 4 populated with data.

Like reference symbols in the various drawings indicate like elements.

### DETAILED DESCRIPTION

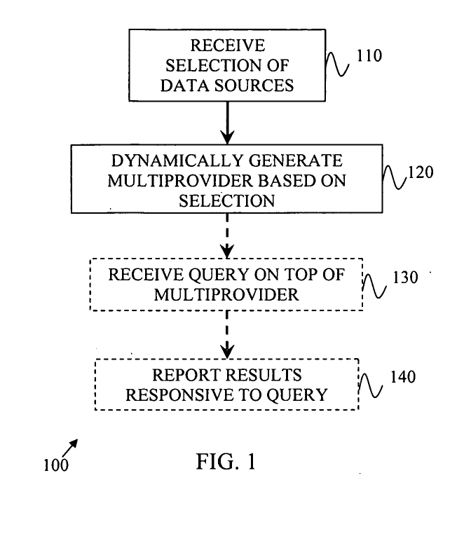

FIG. 1 is a process flow diagram illustrating a method 100 in which, at 110, a selection of a plurality of data sources is received. These data sources characterize (i.e., include, reference, etc.) characteristics and key figures. Thereafter, at 120, a multiprovider based on the selection is dynamically generated (i.e., generated on the fly, etc.) that includes characteristics and key figures from each of the selected data sources. Optionally, at 130, a query on top of the multiprovider is received and, at 140, data responsive to the query is extracted and/or reported.

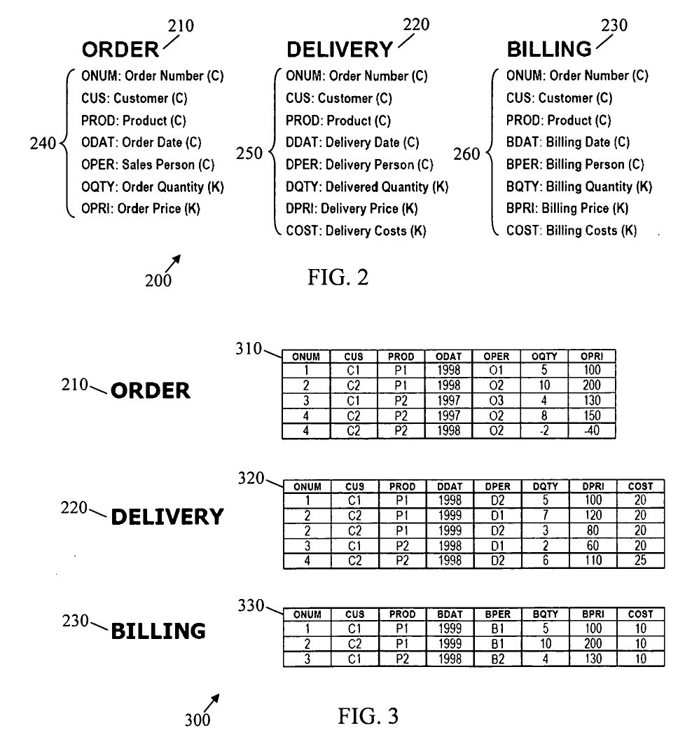

FIG. 2 illustrates three (atomic) infoproviders 210, 220, 230 which originate from a sales-order context. From a simplified point of view, the sales-order process is divided into three sub-processes, namely the ordering process by the customer, the delivery process and the billing process. Each of the descriptions translates 1:1 into an infoprovider. They are referred to as ORDER 210, DELIVERY 220, BILLING 230 respectively and each such infoprovider respectively includes a plurality of items (i.e., infoobjects, sub-processes, etc.) 240, 250, 260.

The “C” designation indicates a characteristic (a kind of descriptive attribute or dimension) while a “K” designation marks key figures (quantitative attributes or measures). It will be noted that three sub-processes—and consequently also their related infoproviders 210, 220, 230—share some common information, namely the order number (ONUM), the customer name (CUST) and the product (PROD) that has been ordered. Some other items are solely associated with a single infoprovider, such as the date on which the respective transaction takes places (ODAT, DDAT, BDAT) or the person handling the transaction (OPER, DPER, BPER). Similarly, key figures can be common among the infoproviders or alternatively solely associated with a single infoprovider. FIG. 3 is a diagram 300 that illustrates sample data 310, 320, 330 that may be held by the respective infoproviders 210, 220, 230.

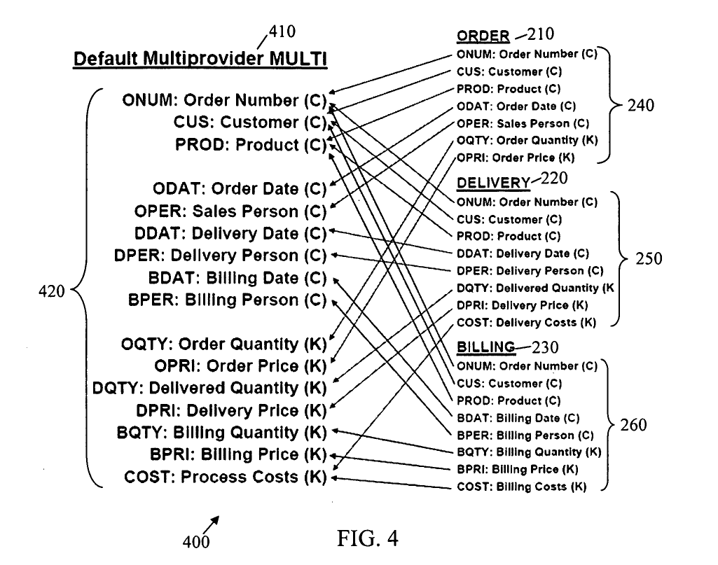

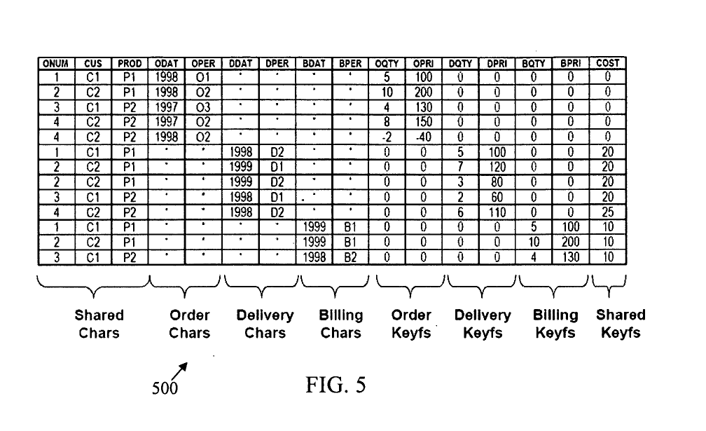

FIG. 4 is a diagram 400 that illustrates a sample mapping of items 240, 250, 260 respectively from the infoproviders 210, 220, 230 to populate items 420 in a multiprovider 410. Such a mapping is derived automatically rather than manually by a user. FIG. 5 is a diagram 500 illustrating how a multiprovider as in FIG. 4 might be populated with data.

The mapping illustrated in FIG. 4 can be derived using an algorithm that commences with a user selecting infoproviders through a graphical user interface (or other input mechanism) that it wants to use in multiprovider M (referred to herein a I₁, I₂, . . . , Iₙ). As a result of this input, multiprovider M is generated that comprises:

1. A list of the selected part-providers P₁, P₂, . . . , Pₙ.

2. A set C of characteristics and a set K of key figures in multiprovider M.

3. A mapping of characteristics and key figures in P₁, P₂, . . . , Pₙ to characteristics and key figures in M.

In some variations, each selected infoprovider is translated into a part-provider of multiprovider M: Pᵢ=Iᵢ for i=1, . . . , n. In addition, union operations such as C={characteristics in P₁} ∪ {characteristics in Pₙ} and/or K={key figures in P₁} ∪ {key figures in Pn} can be performed to remove any duplicate characteristics and/or key figures. Mapping can be performed through matching infoobject names. For example, a characteristic X of a part-provider Pi can be mapped to characteristic X in multiprovider M and the union operation described above can guarantee that there is a characteristic X in multiprovider M. Similarly, a key figure Y of a part-provider Pᵢ can be mapped to key figure Y in multiprovider M and the union operation described above can ensure that there is a key figure Y in multiprovider M.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. An article embodied on tangible media and operable to cause data processing apparatus to perform operations comprising:
receiving a selection of a plurality of data sources, the data sources characterizing characteristics and key figures; and
generating a multiprovider based on the selection, the multiprovider including characteristics and key figures from each of the selected data sources.

2. An article as in claim 1, wherein at least one of the data sources is an infoprovider.

3. An article as in claim 1, wherein duplicative characteristics and key figures from the data sources are removed.

4. An article as in claim 1, wherein each data source comprises a plurality of infoobjects.

5. An article as in claim 1, wherein the article is further operable to cause data processing apparatus to perform operations comprising:
receiving a user-generated query against the multiprovider.

6. An article as in claim 5, wherein the article is further operable to cause data processing apparatus to perform operations comprising:
extracting data from the multiprovider responsive to the query.

7. An article as in claim 1, wherein the multiprovider includes all characteristics and key figures from each of the selected data sources.

8. A computer-implemented method comprising:
receiving a selection of a plurality of data sources, the data sources characterizing characteristics and key figures; and
generating a multiprovider based on the selection, the multiprovider including characteristics and key figures from each of the selected data sources.

9. A method as in claim 8, wherein at least one of the data sources is an Infoprovider.

10. A method as in claim 8, wherein duplicative characteristics and key figures from the data sources are removed.

11. A method as in claim 8, wherein each data source comprises a plurality of infoobjects.

12. A method as in claim 8 further comprising:
receiving a user-generated query against the multiprovider.

13. A method as in claim 12, wherein the article is further operable to cause data processing apparatus to perform operations comprising:
extracting data from the multiprovider responsive to the query.

14. A method as in claim 8, wherein the multiprovider includes all characteristics and key figures from each of the selected data sources.

15. An apparatus comprising:
means for receiving a selection of a plurality of data sources, the data sources characterizing characteristics and key figures;
means for generating a multiprovider based on the selection, the multiprovider including characteristics and key figures from each of the selected data sources;
means for receiving a query against the multiprovider; and
means for reporting data responsive to the query.

16. An apparatus as in claim 15, wherein at least one of the data sources is an Infoprovider.

17. An apparatus as in claim 15, wherein duplicative characteristics and key figures from the data sources are removed.

18. An apparatus as in claim 15, wherein each data source comprises a plurality of infoobjects.

19. An apparatus as in claim 15, wherein the multiprovider includes all characteristics and key figures from each of the selected data sources.

20. An apparatus as in claim 15, wherein the means for generating a multiprovider comprises means for mapping characteristics and key figures from the data sources to infoobjects in the multiprovider.
